(19) United States
(12) Patent Application Publication
(10) Pub. No.: US 2025/0216715 A1
(43) Pub. Date: Jul. 3, 2025

(54) LIQUID CRYSTAL DISPLAY DEVICE

(71) Applicant: Shanghai Tianma Micro-Electronics Co., Ltd., Shanghai (CN)

(72) Inventor: Yosuke NAGASE, Kawasaki (JP)

(73) Assignee: Shanghai Tianma Micro-Electronics Co., Ltd., Shanghai (CN)

(21) Appl. No.: 18/965,040

(22) Filed: Dec. 2, 2024

(30) Foreign Application Priority Data
Dec. 28, 2023 (JP) 2023-222664
Sep. 9, 2024 (JP) 2024-155370

(51) Int. Cl. G02F 1/1335; G02F 1/13357; G02F 1/1343

(52) U.S. Cl. CPC G02F 1/133514; G02F 1/133603; G02F 1/133611; G02F 1/134345

(57) ABSTRACT

An illuminator includes a first illumination region having a first luminance and a second illumination region having a second luminance that is lower. A liquid crystal display includes a first region illuminated by the first illumination region and a second region illuminated by the second illumination region. A pixel in the second region includes a color filter including a first portion having a first transmittance and a second portion having a second transmittance that is higher. A pixel in the first region includes a color filter including only the first portion, or includes a color filter including the first portion and the second portion and a ratio of the second portion to the first portion and the second portion in the pixel in the second region is greater than a ratio of the second portion to the first portion and the second portion in the pixel in the first region.

### CROSS-REFERENCE TO RELATED APPLICATIONS

This application claims the benefit of Japanese Patent Application No. 2023-222664, filed on Dec. 28, 2023, and Japanese Patent Application No. 2024-155370, filed on Sep. 9, 2024, of which the entirety of the disclosures is incorporated by reference herein.

### FIELD OF THE INVENTION

This application relates generally to a liquid crystal display device.

### BACKGROUND OF THE INVENTION

In the related art, liquid crystal display devices include a liquid crystal display panel and, separately, a back light as an illumination device. When there are luminance inconsistencies in the illumination device that supplies light to the display panel, the display uniformity of the liquid crystal display device decreases, which is a problem (for example, see International Publication No. WO2011/033896).

Additionally, a feature called local dimming is known in which the brightness of the back light is controlled by area units in accordance with the brightness of the screen to be displayed to realize high contrast in the liquid crystal display device.

With local dimming, among the divided areas, light emitting elements are not disposed in the area of the outermost periphery and, consequently, the amount of light that is supplied thereto is less than that in the areas other than the outermost periphery, and the luminance of the area of the outermost periphery decreases. This leads to the problem of a decrease in the in-plane luminance uniformity in the display region of the liquid crystal display device.

Accordingly, there is a demand for suppressing the decreases of luminance uniformity in liquid crystal display devices.

### SUMMARY OF THE INVENTION

A liquid crystal display device according to a first embodiment of the present disclosure includes:
an illuminator including a first illumination region having a first luminance, and a second illumination region having a second luminance lower than the first luminance; and
a liquid crystal display including a first region illuminated by the first illumination region, and a second region illuminated by the second illumination region, wherein
a pixel provided in the second region of the liquid crystal display includes a color filter including a first portion having a first transmittance, and a second portion having a second transmittance higher than the first transmittance, and
i) a pixel provided in the first region includes a color filter including only the first portion having the first transmittance, or
ii) a pixel provided in the first region includes a color filter including the first portion having the first transmittance, and the second portion having the second transmittance, wherein a ratio that the second portion occupies with respect to the first portion and the second portion in the pixel provided in the second region of the liquid crystal display is greater than a ratio that the second portion occupies with respect to the first portion and the second portion in the pixel provided in the first region.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a drawing schematically illustrating a liquid crystal display device according to Embodiment 1;

FIG. 2 is a cross-sectional view taken along line II-II illustrated in FIG. 1;

FIG. 3 is a plan view illustrating a back light according to Embodiment 1;

FIG. 4A is a drawing for explaining an illumination region;

FIG. 4B is a drawing illustrating the luminance on line B-B illustrated in FIG. 4A;

FIG. 5 is a drawing for explaining a display region;

FIG. 6A is a plan view illustrating a pixel PX;

FIG. 6B is a plan view illustrating a pixel PX1;

FIG. 6C is a plan view illustrating a pixel PX2;

FIG. 6D is a plan view illustrating a pixel PX3;

FIG. 6E is a plan view illustrating a pixel PX4;

FIG. 7A is a cross-sectional view taken along line VIIA-VIIA illustrated in FIG. 6A;

FIG. 7B is a cross-sectional view taken along line VIIB-VIIB illustrated in FIG. 6B;

FIG. 7C is a cross-sectional view taken along line VIIC-VIIC illustrated in FIG. 6C;

FIG. 7D is a cross-sectional view taken along line VIID-VIID illustrated in FIG. 6D;

FIG. 7E is a cross-sectional view taken along line VIIE-VIIE illustrated in FIG. 6E;

FIG. 8A is a plan view illustrating a pixel PX1 according to Embodiment 2;

FIG. 8B is a plan view illustrating a pixel PX2 according to Embodiment 2;

FIG. 8C is a plan view illustrating a pixel PX3 according to Embodiment 2;

FIG. 9 is a drawing for explaining the effects of Embodiment 2;

FIG. 10A is a plan view illustrating a pixel PX1 according to Embodiment 3;

FIG. 10B is a plan view illustrating a pixel PX2 according to Embodiment 3;

FIG. 10C is a plan view illustrating a pixel PX3 according to Embodiment 3;

FIG. 11A is a cross-sectional view illustrating a pixel PX according to Embodiment 4;

FIG. 11B is a cross-sectional view illustrating a pixel PX1 according to Embodiment 4;

FIG. 11C is a cross-sectional view illustrating a pixel PX2 according to Embodiment 4;

FIG. 11D is a cross-sectional view illustrating a pixel PX3 according to Embodiment 4;

FIG. 11E is a cross-sectional view illustrating a pixel PX4 according to Embodiment 4;

FIG. 12A is a cross-sectional view illustrating a pixel PX according to Embodiment 5;

FIG. 12B is a cross-sectional view illustrating a pixel PX1 according to Embodiment 5;

FIG. 12C is a cross-sectional view illustrating a pixel PX2 according to Embodiment 5;

FIG. 12D is a cross-sectional view illustrating a pixel PX3 according to Embodiment 5;

FIG. 12E is a cross-sectional view illustrating a pixel PX4 according to Embodiment 5;

FIG. 13A is a plan view illustrating a pixel PX according to Embodiment 6;

FIG. 13B is a plan view illustrating a pixel PX1 according to Embodiment 6;

FIG. 13C is a plan view illustrating a pixel PX2 according to Embodiment 6;

FIG. 13D is a plan view illustrating a pixel PX3 according to Embodiment 6;

FIG. 13E is a plan view illustrating a pixel PX4 according to Embodiment 6;

FIG. 14A is a cross-sectional view taken along line XIVa-XIVa illustrated in FIG. 13A;

FIG. 14B is a cross-sectional view taken along line XIVb-XIVb illustrated in FIG. 13A;

FIG. 14C is a cross-sectional view taken along line XIVc-XIVc illustrated in FIG. 13A;

FIG. 14D is a cross-sectional view taken along line XIVd-XIVd illustrated in FIG. 13B;

FIG. 14E is a cross-sectional view taken along line XIVe-XIVe illustrated in FIG. 13B;

FIG. 14F is a cross-sectional view taken along line XIVf-XIVf illustrated in FIG. 13B;

FIG. 14G is a cross-sectional view taken along line XIVg-XIVg illustrated in FIG. 13C;

FIG. 14H is a cross-sectional view taken along line XIVh-XIVh illustrated in FIG. 13C;

FIG. 14I is a cross-sectional view taken along line XIVi-XIVi illustrated in FIG. 13C;

FIG. 15J is a cross-sectional view taken along line XVj-XVj illustrated in FIG. 13D;

FIG. 15K is a cross-sectional view taken along line XVk-XVk illustrated in FIG. 13D;

FIG. 15L is a cross-sectional view taken along line XVl-XVl illustrated in FIG. 13D;

FIG. 15M is a cross-sectional view taken along line XVm-XVm illustrated in FIG. 13E;

FIG. 15N is a cross-sectional view taken along line XVn-XVn illustrated in FIG. 13E;

FIG. 15O is a cross-sectional view taken along line XVo-XVo illustrated in FIG. 13E;

FIG. 16A is a plan view illustrating a pixel PX according to Embodiment 7;

FIG. 16B is a plan view illustrating a pixel PX1 according to Embodiment 7;

FIG. 16C is a plan view illustrating a pixel PX2 according to Embodiment 7;

FIG. 16D is a plan view illustrating a pixel PX3 according to Embodiment 7;

FIG. 16E is a plan view illustrating a pixel PX4 according to Embodiment 7;

FIG. 17A is a cross-sectional view taken along line XVIIa-XVIIa illustrated in FIG. 16A;

FIG. 17B is a cross-sectional view taken along line XVIIb-XVIIb illustrated in FIG. 16A;

FIG. 17C is a cross-sectional view taken along line XVIIc-XVIIc illustrated in FIG. 16A;

FIG. 17D is a cross-sectional view taken along line XVIId-XVIId illustrated in FIG. 16B;

FIG. 17E is a cross-sectional view taken along line XVIIe-XVIIe illustrated in FIG. 16B;

FIG. 17F is a cross-sectional view taken along line XVIIf-XVIIf illustrated in FIG. 16B;

FIG. 17G is a cross-sectional view taken along line XVIIg-XVIIg illustrated in FIG. 16C;

FIG. 17H is a cross-sectional view taken along line XVIIh-XVIIh illustrated in FIG. 16C;

FIG. 17I is a cross-sectional view taken along line XVIIi-XVIIi illustrated in FIG. 16C;

FIG. 18J is a cross-sectional view taken along line XVIIIj-XVIIIj illustrated in FIG. 16D;

FIG. 18K is a cross-sectional view taken along line XVIIIk-XVIIIk illustrated in FIG. 16D;

FIG. 18L is a cross-sectional view taken along line XVIIIl-XVIIIl illustrated in FIG. 16D;

FIG. 18M is a cross-sectional view taken along line XVIIIm-XVIIIm illustrated in FIG. 16E;

FIG. 18N is a cross-sectional view taken along line XVIIIn-XVIIIn illustrated in FIG. 16E; and

FIG. 18O is a cross-sectional view taken along line XVIIIo-XVIIIo illustrated in FIG. 16E.

### DETAILED DESCRIPTION OF THE INVENTION

In the following, a liquid crystal display device according to various embodiments is described while referencing the drawings.

### Embodiment 1

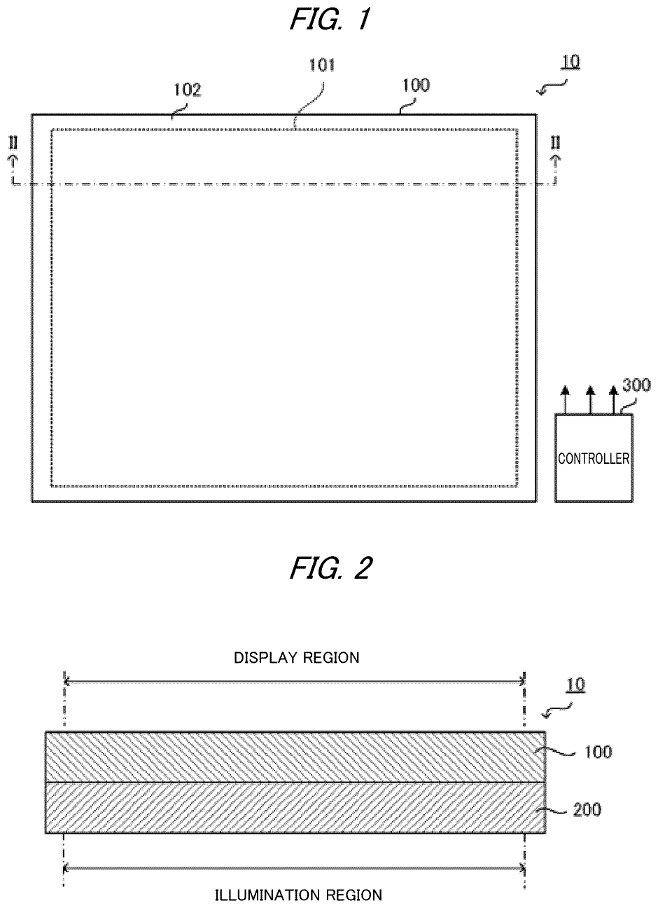

As illustrated in FIGS. 1 and 2, a liquid crystal display device 10 according to the present embodiment includes a liquid crystal display panel (liquid crystal display) 100, a back light (illuminator) 200, and a controller 300. The liquid crystal display panel 100 displays characters and/or images. As illustrated in FIG. 2, the back light 200 is provided overlapping the liquid crystal display panel 100, and emits light on the liquid crystal display panel 100. The controller 300 controls the displaying of the liquid crystal display panel 100 and the luminance of the back light 200.

In one example, the liquid crystal display panel 100 is implemented as a horizontal electric field type color liquid crystal display panel that is active matrix driven by thin film transistors (TFT). As illustrated in FIG. 1, the liquid crystal display panel 100 includes a display region 101 in which pixels, including three subpixels, namely red (R), green (G), and blue (B), are arranged in a matrix, and a frame region 102 in which wirings, drive circuits, and the like are disposed. Here, the frame region 102 surrounds the display region 101. The display region 101 is a region that is capable of displaying characters, images, and the like, and the frame region 102 is a region incapable of displaying characters, images, and the like.

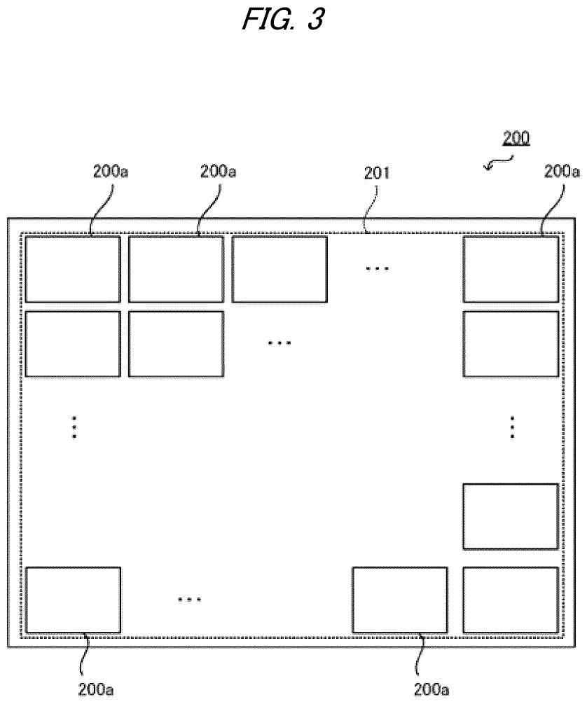

The back light 200 of the present embodiment is implemented as a local dimming light and, as illustrated in FIG. 3, includes a plurality of emission regions 200a. An illumination region 201 of the back light 200 is a region that includes the plurality of emission regions 200a, and is a region that illuminates the liquid crystal display panel 100. The back light 200 includes a white light emitting diode (LED) element, a reflective sheet, a diffusion sheet, a lighting circuit, and the like (all not illustrated in the drawings). In the back light 200 of the present embodiment, in one example, one or a plurality of white LED elements is disposed in each of the emission regions 200a.

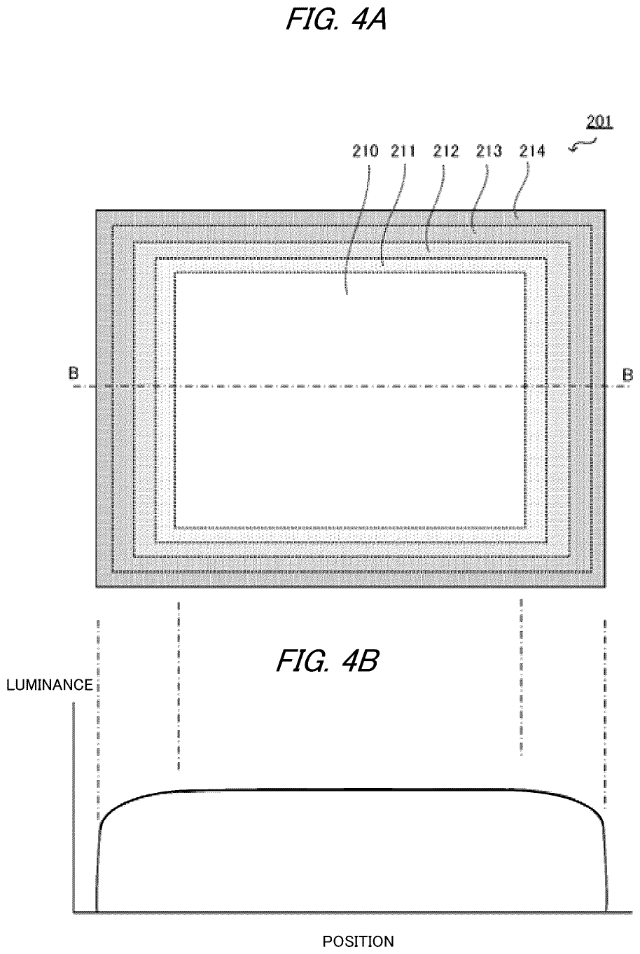

FIG. 4A illustrates the illumination region 201 of the back light 200. FIG. 4A corresponds to a plan view of the back light 200, observed from the side of a user. FIG. 4B is a graph illustrating the luminance on the line B-B illustrated in FIG. 4A. As illustrated in FIG. 3, the back light 200 of the present embodiment includes the plurality of emission regions 200a. As such, as illustrated in FIG. 4B, although a central illumination region 210 of the illumination region 201 has substantially the same luminance, the luminance decreases with distance from the central illumination region 210 toward the outer periphery. In one example, the decrease in the luminance is from 20 to 30%.

Based on the luminance distribution of FIG. 4B, illumination regions are set in accordance to the degree that the luminance decreases from the position at which the luminance starts to decrease compared to the central illumination region 210. Specifically, as illustrated in FIG. 4A, a region, from the position at which the luminance starts to decrease, in which the luminance is lower than that of the central illumination region 210 is set as a first illumination region 211. Additionally, a region in which the luminance is lower than in the first illumination region 211 is set as a second illumination region 212. Likewise, a region in which the luminance is lower than in the second illumination region 212 is set as a third illumination region 213, and a region in which the luminance is lower than in the third illumination region 213 is set as a fourth illumination region 214. In the present embodiment, in the back light 200, the luminance gradually decreases from the center toward the outer periphery and, as such, the first illumination region 211 surrounds the central illumination region 210, and the second illumination region 212 surrounds the first illumination region 211. Furthermore, the third illumination region 213 surrounds the second illumination region 212, and the fourth illumination region 214 surrounds the third illumination region 213. In the first illumination region 211 to the fourth illumination region 214, the luminance need not be uniform within each plane, and it is sufficient that the luminance is within a specific numerical value range.

The controller 300 includes a central processing unit (CPU), a memory, and the like, and controls the display of the liquid crystal display panel 100 and the luminance of the back light 200. In one example, the CPU executes programs stored in the memory to realize the functions of the controller 300.

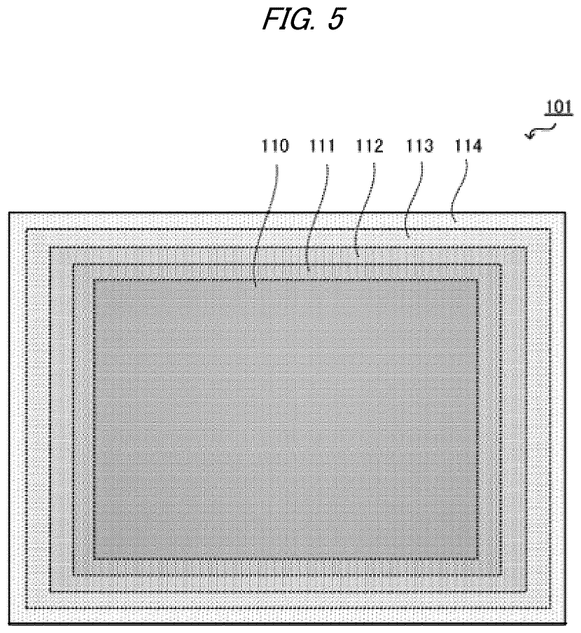

Next, FIG. 5 illustrates the display region 101 of the liquid crystal display panel 100. In the present embodiment, as described in detail later, transmittances of color filters provided in the subpixels of pixels PX to PX4 in the display region 101 differ from each other. The transmittance of the color filter is determined in accordance with the luminance of the illumination region 201 of the back light 200 that illuminates the display region 101.

Firstly, a central region 110 of the display region 101 is illuminated by the central illumination region 210 of the illumination region 201. A first region 111 of the display region 101 is illuminated by the first illumination region 211, and a second region 112 of the display region 101 is illuminated by the second illumination region 212. Likewise, a third region 113 of the display region 101 is illuminated by the third illumination region 213, and a fourth region 114 of the display region 101 is illuminated by the fourth illumination region 214.

As described above, in the back light 200, the luminance decreases in the order of the central illumination region 210, the first illumination region 211, the second illumination region 212, the third illumination region 213, and the fourth illumination region 214. Accordingly, in the liquid crystal display panel 100, the transmittance of light from the back light 200 is increased in the order of the central region 110, the first region 111, the second region 112, the third region 113, and the fourth region 114. In one example, the luminance of the back light 200 decreases by 20˜30% at the periphery portion compared to the central portion. It is preferable that the difference in the surface luminance of the liquid crystal display device 10 be set to 15% or less by adjusting the transmittance of the liquid crystal display panel 100.

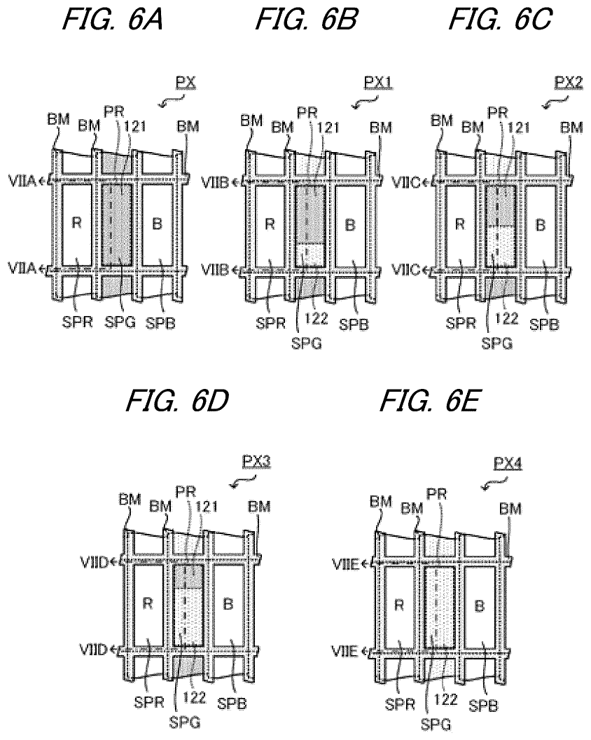

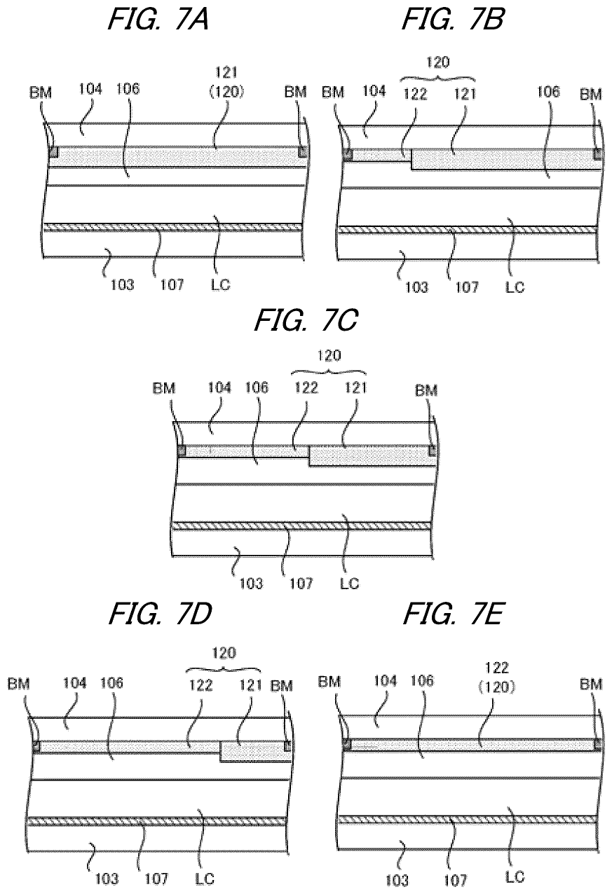

Next, FIG. 6A illustrates a pixel PX provided in the central region 110. A pixel PX1 provided in the first region 111 is illustrated in FIG. 6B, a pixel PX2 provided in the second region 112 is illustrated in FIG. 6C, a pixel PX3 provided in the third region 113 is illustrated in FIG. 6D, and a pixel PX4 provided in the fourth region 114 is illustrated in FIG. 6E. FIG. 7A is a cross-sectional view taken along line VIIA-VIIA illustrated in FIG. 6A. FIG. 7B is a cross-sectional view taken along line VIIB-VIIB illustrated in FIG. 6B, FIG. 7C is a cross-sectional view taken along line VIIC-VIIC illustrated in FIG. 6C, FIG. 7D is a cross-sectional view taken along line VIID-VIID illustrated in FIG. 6D, and FIG. 7E is a cross-sectional view taken along line VIIE-VIIE illustrated in FIG. 6E. In the present embodiment, an example of a configuration is described in which a high transmittance region is provided in only the G color filter among the RGB color filters.

Firstly, as illustrated in FIGS. 7A to 7E, the liquid crystal display panel 100 includes an active matrix substrate 103, a counter substrate 104, and a liquid crystal LC. The counter substrate 104 is adhered to the active matrix substrate 103 by a seal material (not illustrated in the drawings). Additionally, the liquid crystal display panel 100 includes a polarizing plate (not illustrated in the drawings) provided on a lower surface of the active matrix substrate 103, and a polarizing plate (not illustrated in the drawings) provided on an upper surface of the counter substrate 104. In one example, the counter substrate 104 is implemented as a glass substrate. As illustrated in FIG. 4, a color filter 120, an overcoat film 106, and an alignment film (all not illustrated in the drawings) are provided on the surface of the counter substrate 104 opposing the active matrix substrate 103. Additionally, in the present embodiment, the overcoat film 106 is formed thickly. Due to this, the occurrence of disclination within the pixel at a step caused by the second portion 122 of the color filter 120 is prevented.

In one example, the active matrix substrate 103 is implemented as a glass substrate. Pixel electrodes, gate lines, data lines, switching elements, and the like (all not illustrated in the drawings) are provided on a surface of the active matrix substrate 103 opposing the counter substrate 104. Note that, in FIGS. 7A to 7E, to facilitate comprehension, these switching elements, pixel electrodes, and the like are illustrated collectively as an electrode forming layer 107.

As illustrated in FIG. 6A, the pixel PX provided in the central region 110 includes a red subpixel SPR, a green subpixel SPG, and a blue subpixel SPB. In the present embodiment, a high transmittance region is provided in the color filter 120 of the green subpixel SPG. Additionally, within the subpixel SPG, the region capable of displaying is a pixel region PR defined by the black matrix BM.

As illustrated in FIG. 6A, in the pixel PX, the color filter 120 in the pixel region PR includes only the first portion 121 that has a reference thickness and the first transmittance. In other words, when viewing the pixel PX planarly from the user side, the ratio of the area that the second portion 122 occupies in the pixel region PR is zero. Additionally, as illustrated in FIG. 7A, the color filter includes only the first portion 121.

In the pixel PX1 provided in the first region 111 surrounding the central region 110, the color filter 120 includes the first portion 121 having the first transmittance and the second portion 122 having a second transmittance higher than the first transmittance. As illustrated in FIG. 6B, the pixel region PR includes the first portion 121 and the second portion 122. When viewing the pixel PX1 planarly, a ratio of the area of the second portion 122 to the combined area of the first portion 121 and the second portion 122 is greater compared to that of the pixel PX. As such, the color filter 120 of the pixel PX1 has a higher transmittance than the color filter 120 of the pixel PX. As illustrated in FIG. 7B, in the pixel PX1, a thickness of the second portion 122 of the color filter 120 is formed thinner than that of the first portion 121.

In the pixel PX2 provided in the second region 112 surrounding the first region 111, the color filter 120 includes the first portion 121 having the first transmittance and the second portion 122 having the second transmittance higher than the first transmittance. As illustrated in FIG. 6C, the pixel region PR of the pixel PX2 includes more of the second portion 122 than the pixel PX1. Accordingly, when viewing the pixel PX2 planarly, the ratio of the area of the second portion 122 to the combined area of the first portion 121 and the second portion 122 is greater than in the pixel PX1. As such, the color filter 120 of the pixel PX2 has a higher transmittance than the color filter 120 of the pixel PX1. As illustrated in FIG. 7C, in the pixel PX2 as well, the thickness of the second portion 122 of the color filter 120 is formed thinner than that of the first portion 121.

As illustrated in FIG. 6D, in the pixel PX3 provided in the third region 113 surrounding the second region 112 as well, the color filter 120 includes the first portion 121 having the first transmittance and the second portion 122 having the second transmittance higher than the first transmittance. As illustrated in FIG. 6D, when viewing the pixel PX3 planarly, the ratio of the area of the second portion 122 to the combined area of the first portion 121 and the second portion 122 is greater than in the pixel PX2. As such, the color filter 120 of the pixel PX3 has a higher transmittance than the color filter 120 of the pixel PX2. As illustrated in FIG. 7D, in the pixel PX3 as well, the thickness of the second portion 122 of the color filter 120 is formed thinner than that of the first portion 121.

Note that the thickness differences of the color filter 120 as illustrated in FIGS. 7B to 7D can be manufactured by using a half-tone mask.

As illustrated in FIGS. 6E and 7E, in the pixel PX4 provided in the fourth region 114 surrounding the third region 113, the color filter 120 includes only the second portion 122 having the second transmittance. In other words, when viewing the pixel PX4 planarly from the user side, the ratio of the area that the second portion 122 occupies in the pixel region PR is 1, and the transmittance of the color filter 120 of the pixel PX4 is higher than that of the pixel PX3.

In the present embodiment, in the pixels PX to PX4, the transmittance can be increased from the pixel PX to the pixel PX4 by sequentially increasing the ratio, to the area when viewing the pixel region PR planarly, of the area of the second portion 122 having the transmittance higher than that of the first portion 121.

With the liquid crystal display device 10 of the present embodiment, the second portion 122 having a high transmittance of the light of the back light 200 is provided in the pixels PX1 to PX4 provided in the first region 111 to the fourth region 114 provided in the liquid crystal display panel 100. Due to this, decreases in the luminance of the back light 200 are compensated for by the liquid crystal display panel 100 and, as a result, the in-plane luminance uniformity on the surface of the liquid crystal display device 10 can be enhanced. Furthermore, it is possible to suppress luminance decreases of the surface of the liquid crystal display device 10 and enhance the in-plane uniformity by gradually increasing, from the first region 111 to the fourth region 114 and in accordance with the luminance decreases, the ratio at which the high-transmittance second portion 122 is provided.

Additionally, in the liquid crystal display device 10 of the present embodiment, due to the transmittance of the color filter being increased, the need to increase the brightness of the back light 200 in order to improve the luminance is eliminated, and power consumption does not increase.

Furthermore, in the liquid crystal display device 10 of the present embodiment, it is possible to suppress decreases in the luminance of the outer periphery of the display region 101. For example, in a case in which conventional liquid crystal display devices are used as a tiled display, there is a problem in that, when low luminance regions are positioned on the periphery of each liquid crystal display device, the seams between the displays are noticeable. However, with the liquid crystal display device 10 of the present embodiment, it is possible to suppress decreases in the luminance of the periphery of the display region 101 and, as such, an effect of being able to make the seams between the displays less noticeable can be obtained.

Note that, in the present embodiment, an example is described of a configuration in which the high transmittance second portion is provided in green among red, green, and blue, but the color in which the high transmittance second portion is provided is not limited to green. It is sufficient that the second portion is provided in at least one color among the red, green, and blue color filter. That is, a configuration is possible in which the second portion is provided only in one color among the red, green, and blue color filters, a configuration is possible in which the second portion is provided in two colors of the color filters, and a configuration is possible in which the second portion is provided in all three colors of the color filters. However, a change in the thickness of the color filter also causes a change in chromaticity. It is preferable that this change in chromaticity is in a range that is difficult for the user to visually recognize. Although there are differences depending on the material used, green tends to be the least visibly recognizable on the basis of a change in chromaticity due to a change in film thickness, followed by red. As such, it is preferable that the second portion is provided in the green color filter, and it is next preferable that the second portion is provided in the red color filter.

In the present embodiment, an example is described of a configuration in which the planar shape of the high transmittance second portion 122 is square, but the planar shape of the second portion 122 can be set as desired. For example, the planar shape of the second portion 122 may be polygonal, circular, elliptical, or the like.

### Embodiment 2

In the following, a liquid crystal display device 10 according to Embodiment 2 is described. The present embodiment is characterized in that the arrangement of the first portion 121 and the second portion 122 of the color filter 120 differs from in Embodiment 1. The features common with Embodiment 1 are denoted with the same reference numerals, and detailed descriptions thereof are forgone.

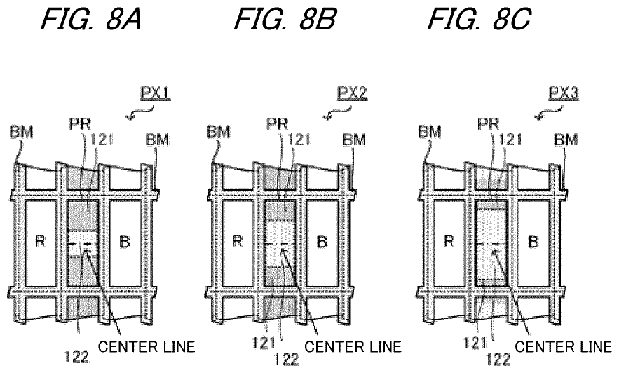

Pixels PX1 to PX3 according to the present embodiment are illustrated in FIGS. 8A to 8C. FIGS. 8A to 8C respectively correspond to FIGS. 6B to 6D of Embodiment 1. The pixels PX1 to PX3 of FIGS. 8A to 8C are respectively provided in the first region 111, the second region 112, and the third region 113. Note that the configurations of the pixel PX and the pixel PX4 are the same as in Embodiment 1 and, as such, descriptions thereof are forgone.

In the present embodiment, the second portion 122 is provided so as to extend from the center toward both vertical ends of the pixel region PR. As illustrated in FIG. 8A, in the color filter 120 of the pixel PX1, the second portion 122 that has a high transmittance is provided in the central portion of the pixel PX1, and the first portion 121 that has a low transmittance is provided above and below the second portion 122. In particular, the first portion 121 and the second portion 122 are arranged so as to be line symmetric with respect to a transverse direction center line of the pixel region PR illustrated in FIG. 8A. By arranging in this manner, the ratio that the area of the second portion 122 occupies relative to the total area of the first portion 121 and the second portion 122 can be made the same for the region of the upper half and the region of the lower half of the pixel region PR. Additionally, as illustrated in FIGS. 8B and 8C, when increasing the ratio of the second portion 122, the area of the second portion 122 provided in the central portion of the pixels PX2 and PX3 is increased.

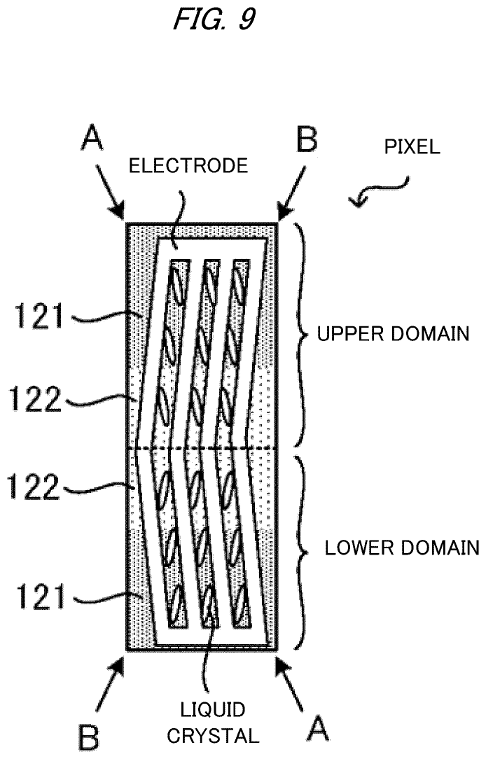

FIG. 9 is a drawing for explaining the effects of the present embodiment. As illustrated in FIG. 9, the electrode is bent at the central portion of the pixel, thereby providing the pixel with a multi-domain structure. In this case, the ratio that the second portion 122 occupies with respect to the first portion 121 and the second portion 122 in the upper domain, and the ratio that the second portion 122 occupies with respect to the first portion 121 and the second portion 122 in the lower domain are made the same.

It is known that light on the short wavelength side appears stronger when viewing a liquid crystal from the long axis direction, and light on the long wavelength side appears stronger when viewing from the short axis direction. When providing the first portion 121 and the second portion 122 as in FIG. 9, the transmittances of the upper domain and the lower domain can be made equivalent. Accordingly, there will be no difference between the color when viewed from the A direction and the color when viewed from the B direction. As a result, it is possible to prevent the occurrence of color differences caused by the high transmittance second portion 122 in the pixel.

Making, in each domain, the ratio that the second portion 122 occupies with respect to first portion 121 and second portion 122 the same is particularly advantageous in the case of multi-domain structures.

### Embodiment 3

In the following, a liquid crystal display device 10 according to Embodiment 3 is described. The present embodiment is characterized in that the arrangement of the first portion 121 and the second portion 122 of the color filter 120 differs from that in Embodiments 1 and 2. The features common with Embodiments 1 and 2 are denoted with the same reference numerals, and detailed descriptions thereof are forgone.

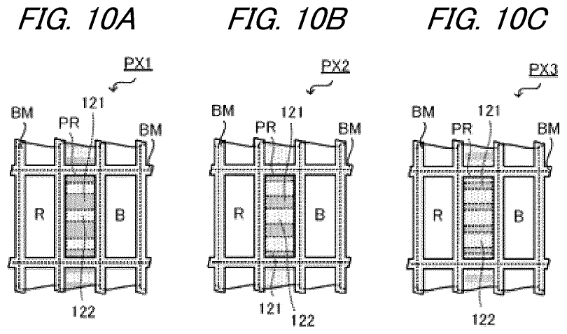

Pixels PX1 to PX3 according to the present embodiment are illustrated in FIGS. 10A to 10C. FIGS. 10A to 10C respectively correspond to FIGS. 6B to 6D of Embodiment 1. The pixels PX1 to PX3 of FIGS. 10A to 10C are respectively provided in the first region 111, the second region 112, and the third region 113. Note that the configurations of the pixel PX and the pixel PX4 are the same as in Embodiment 1 and, as such, descriptions thereof are forgone.

In the present embodiment, as illustrated in FIGS. 10A to 10C, a plurality of second portions 122 is arranged in a stripe manner. This makes it possible to arrange the first portion 121 and the second portion 122 at a fine pitch. Note that, in FIGS. 10A to 10C, an example is illustrated of stripes that extend in the transverse direction of the pixel, but stripes that extend in the longitudinal direction are possible and stripes that extend in a diagonal direction are also possible.

When the pitch of the first portion 121 and the second portion 122 of the color filter 120 is great, luminance differences may be visually recognized as streak-like inconsistencies. In such a case, when the pitch of a thin portion and a reference thickness portion of the color resist is great, there is a concern that luminance differences may be visually recognized as streak-like inconsistencies. By providing the second portion 122 at a plurality of locations as in the present embodiment, the pitch of the first portion 121 and the second portion 122 becomes finer, which makes it possible to prevent such streak-like inconsistencies from being visually recognized.

### Embodiment 4

In the following, a liquid crystal display device 10 according to Embodiment 4 is described. In the embodiments described above, the thicknesses of the first portion 121 and the second portion 122 of the color filter 120 are changed to vary the transmittance. However, in the present embodiment, the materials used for the first portion and the second portion are varied to vary the transmittance. The features common with the embodiments described above are denoted with the same reference numerals, and detailed descriptions thereof are forgone.

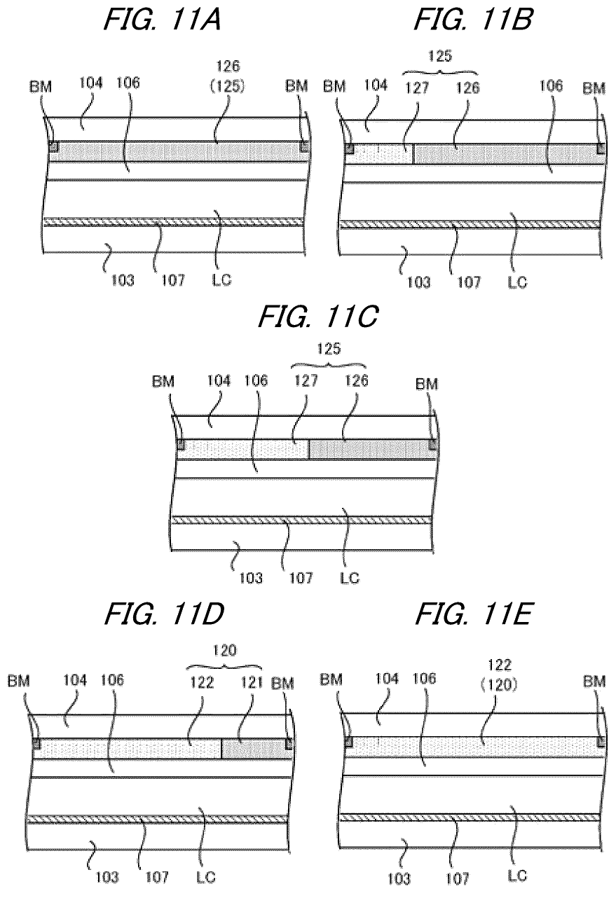

Pixels PX to PX4 according to the present embodiment are illustrated in FIGS. 11A to 11E. FIGS. 11A to 11E respectively correspond to the cross-sectional views taken along the various lines of FIGS. 6A to 6E of Embodiment 1. The pixels PX to PX4 of FIGS. 11A to 11E are respectively provided in the central region 110, the first region 111, the second region 112, the third region 113, and the fourth region 114.

In the present embodiment, in the pixels PX1 to PX3, each color filter 125 has the same flat shape as in FIGS. 6B to 6D of Embodiment 1. Additionally, as illustrated in FIGS. 11B to 11D, the color filter 125 includes a first portion 126 having a first transmittance and a second portion 127 having a second transmittance higher than the first transmittance. In the present embodiment, the second portion 127 is formed from a material having a higher transmittance of light than the first portion 126 at the same thickness and, as a result, as illustrated in FIGS. 11B to 11D, the first portion 126 and the second portion 127 of the color filter 125 are formed having the same thickness.

When varying the materials of the first portion 126 and the second portion 127 as in the present embodiment, it is necessary to prepare two types of resists for forming the color filter, and the color filter must be formed using different processes. However, since the thicknesses are the same, there is a benefit in that the need to use a half-tone mask is eliminated.

Additionally, since a step is not formed in the color filter 125 of the pixels PX1 to PX3, there is a benefit in that the possibility of disclination can be reduced.

### Embodiment 5

In the following, a liquid crystal display device 10 according to Embodiment 5 is described. In Embodiment 1 described above, the overcoat film 106 is formed thickly with respect to the color filter 120 to prevent a step of the overcoat film 106 from forming. However, in the present embodiment, an overcoat film 108 includes a step, and a cell gap is widened in the region in which the second portion 122 is provided. The features common with the embodiments described above are denoted with the same reference numerals, and detailed descriptions thereof are forgone.

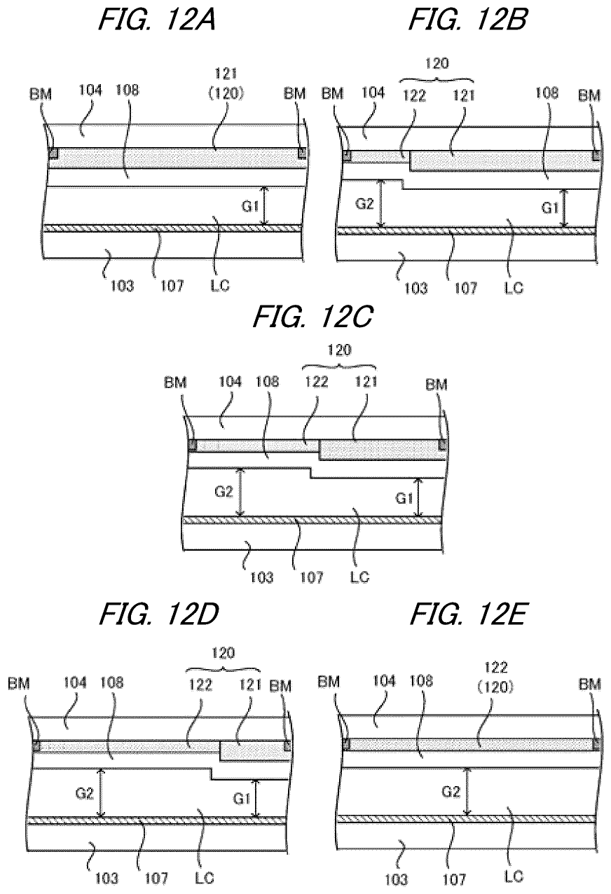

Pixels PX to PX4 according to the present embodiment are illustrated in FIGS. 12A to 12E. FIGS. 12A to 12E respectively correspond to the cross-sectional views taken along the various lines of FIGS. 6A to 6E of Embodiment 1. The pixels PX to PX4 of FIGS. 12A to 12E are respectively provided in the central region 110, the first region 111, the second region 112, the third region 113, and the fourth region 114.

In the present embodiment, in the pixels PX1 to PX3, each color filter 120 has the same flat shape as in FIGS. 6B to 6D of Embodiment 1. Additionally, as illustrated in FIGS. 12B to 12D, the color filter 120 includes the first portion 121 having the first transmittance and the second portion 122 having the second transmittance higher than the first transmittance. In the present embodiment, as in Embodiment 1, the second portion 122 is formed having a thickness that is less than that of the first portion 121. A step is formed in overcoat film 108 due to the difference in the thicknesses of the first portion 121 and the second portion 122. A cell gap of the region in which the first portion 121 is provided is G1, a cell gap of the region in which the second portion 122 is provided is G2, and G2 is greater than G1 (G2>G1). Additionally, the cell gap is G2 in the pixel PX4, of which the entirely is the second portion 122.

The transmittance of light tends to increase in regions in which the cell gap has increased. As such, it is possible to increase the transmittance more by increasing the cell gap of the region in which the second portion 122 is provided.

Accordingly, in the liquid crystal display device of the present embodiment, it is, furthermore, possible to increase the transmittance of light in the pixels PX1 to PX4.

### Embodiment 6

In the following, a liquid crystal display device 10 according to Embodiment 6 is described. In Embodiment 1 described above, an example is described of a configuration in which the high transmittance second portion is provided in the color filter of one color among red, green, and blue. However, in the present embodiment, the high transmittance second portion is provided in two or more colors among red, green, and blue, and the area ratio of the second portion in each of the red, green, and blue pixels is varied. The features common with the embodiments described above are denoted with the same reference numerals, and detailed descriptions thereof are forgone.

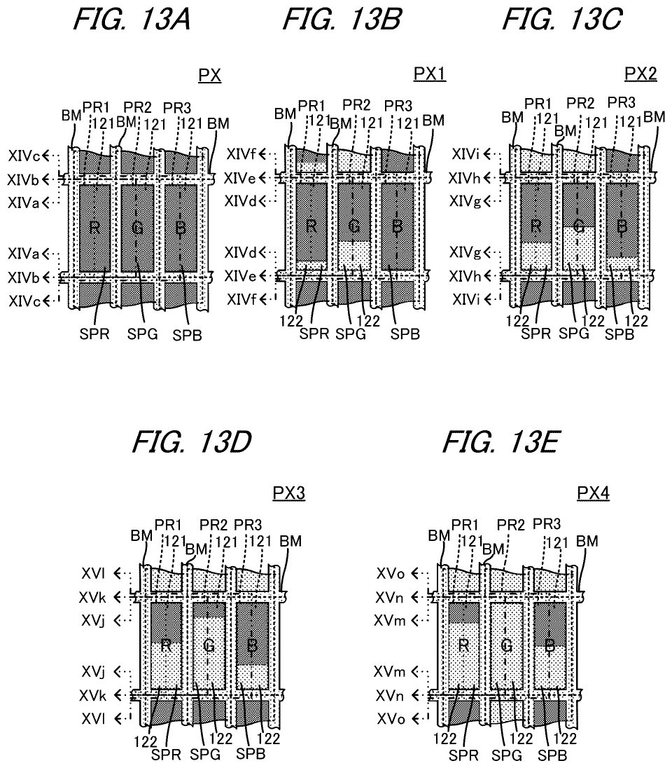

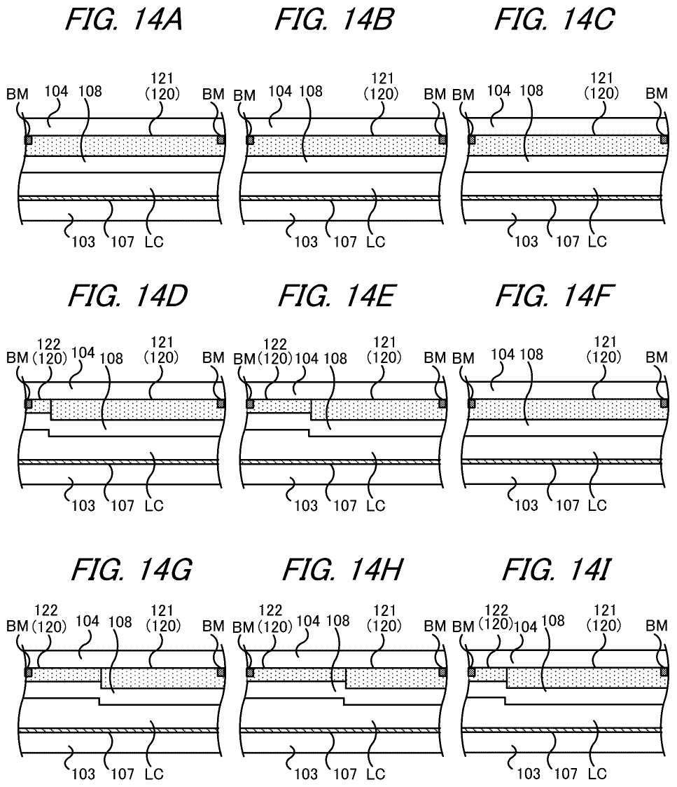

Pixels PX to PX4 according to the present embodiment are illustrated in FIGS. 13A to 13E. As illustrated in FIG. 13A, in the pixel PX, the color filter 120 in the pixel region PR1 of the red subpixel SPR, the pixel region PR2 of the green subpixel SPG, and the pixel region PR3 of the blue subpixel SPB includes only the first portion 121 that has a reference thickness and the first transmittance. In other words, when viewing the pixel PX planarly from the user side, the ratio of the area that the second portion 122 occupies in the pixel regions PR1 to PR3 is zero. FIG. 14A is a cross-sectional view taken along line XIVa-XIVa and is a cross-section of the subpixel SPR illustrated in FIG. 13A. FIG. 14B is a cross-sectional view taken along line XIVb-XIVb and is a cross-section of the subpixel SPG illustrated in FIG. 13A. FIG. 14C is a cross-sectional view taken along line XIVc-XIVc and is a cross-section of the subpixel SPB illustrated in FIG. 13A. As illustrated in FIGS. 14A to 14C, the red, green, and blue color filters include only the first portion 121.

In the pixel PX1, the color filter 120 includes the first portion 121 having the first transmittance and the second portion 122 having the second transmittance higher than the first transmittance. As illustrated in FIG. 13B, the pixel regions PR1 and PR2 include the first portion 121 and the second portion 122. FIG. 14D is a cross-sectional view taken along line XIVd-XIVd and is a cross-section of the subpixel SPR illustrated in FIG. 13B. FIG. 14E is a cross-sectional view taken along line XIVe-XIVe and is a cross-section of the subpixel SPG illustrated in FIG. 13B. FIG. 14F is a cross-sectional view taken along line XIVf-XIVf and is a cross-section of the subpixel SPB illustrated in FIG. 13B. As illustrated in FIGS. 14D to 14F, the blue color filter includes only the first portion 121, and the red and green color filters include the first portion 121 and the second portion 122. In the pixel PX1, the thickness of the second portion 122 of the color filter 120 is formed thinner than that of the first portion 121. When viewing the pixel PX1 planarly, the ratio of the area of the second portion 122 to the combined area of the first portion 121 and the second portion 122 is greater in the pixel regions PR1 and PR2, compared to that of the pixel PX. As such, the color filter 120 of the pixel PX1 has a higher transmittance than the color filter 120 of the pixel PX. Here, the ratio of the area of the second portion 122 in the pixel region PR1 and the ratio of the area of the second portion 122 in the pixel region PR2 are not the same, that is, the ratio of the area of the second portion 122 in the pixel region PR2 is greater. Furthermore, as with the pixel PX, the ratio of the area that the second portion 122 occupies in the pixel region PR3 is zero. Accordingly, the ratio of the area of the second portion 122 in the pixel region PR3 differs from the ratio of the area of the second portion 122 in the pixel regions PR1 and PR2.

In the pixel PX2, the color filter 120 includes the first portion 121 having the first transmittance and the second portion 122 having the second transmittance higher than the first transmittance. As illustrated in FIG. 13C, the pixel regions PR1 and PR2 of the pixel PX2 include more of the second portion 122 than the pixel PX1. Furthermore, in contrast with the pixel PX1, the pixel region PR3 includes the second portion 122 in addition to the first portion 121. Accordingly, when viewing the pixel PX2 planarly, the ratio of the area of the second portion 122 to the combined area of the first portion 121 and the second portion 122 is greater than in the pixel PX1. As such, the color filter 120 of the pixel PX2 has a higher transmittance than the color filter 120 of the pixel PX1. Here, the ratios of the area that the second portion 122 occupies in each of the pixel regions PR1, PR2, and PR3 are not the same, that is, the ratio of the area that the second portion 122 occupies increases in the order of the pixel region PR3, PR1, and PR2. FIG. 14G is a cross-sectional view taken along line XIVg-XIVg and is a cross-section of the subpixel SPR illustrated in FIG. 13C. FIG. 14H is a cross-sectional view taken along line XIVh-XIVh and is a cross-section of the subpixel SPG illustrated in FIG. 13C. FIG. 14I is a cross-sectional view taken along line XIVi-XIVi and is a cross-section of the subpixel SPB illustrated in FIG. 13C. As illustrated in FIGS. 14G to 14I, the red, green, and blue color filters include the first portion 121 and the second portion 122 and, in the pixel PX2 as well, the thickness of the second portion 122 of the color filter 120 is formed thinner than that of the first portion 121.

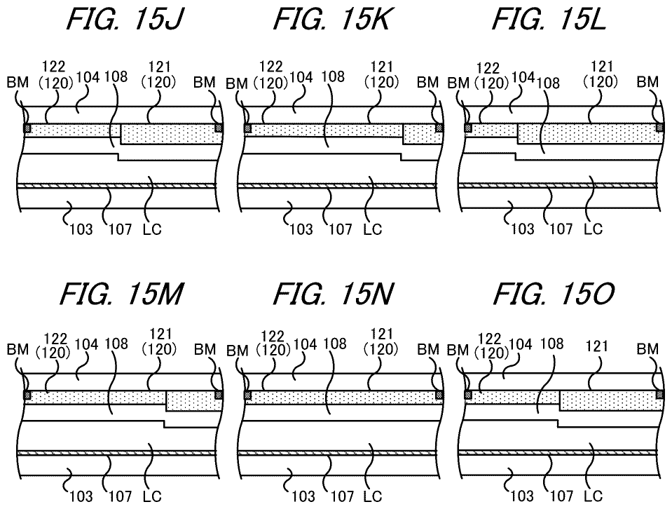

Furthermore as illustrated in FIG. 13D, in the pixel PX3 as well, the color filter 120 includes the first portion 121 having the first transmittance and the second portion 122 having the second transmittance higher than the first transmittance. When viewing the pixel PX3 planarly, the ratio of the area of the second portion 122 to the combined area of the first portion 121 and the second portion 122 is greater compared to that of the pixel PX2 illustrated in FIG. 13C. As such, the color filter 120 of the pixel PX3 has a higher transmittance than the color filter 120 of the pixel PX2. Here, as in the pixel PX2, the ratios of the area that the second portion 122 occupies in each of the pixel regions PR1, PR2, and PR3 are not the same, that is, the ratio of the area that the second portion 122 occupies increases in the order of the pixel region PR3, PR1, and PR2. FIG. 15J is a cross-sectional view taken along line XVj-XVj and is a cross-section of the subpixel SPR illustrated in FIG. 13D. FIG. 15K is a cross-sectional view taken along line XVk-XVk and is a cross-section of the subpixel SPG illustrated in FIG. 13D. FIG. 15L is a cross-sectional view taken along line XVI-XVI and is a cross-section of the subpixel SPB illustrated in FIG. 13D. As illustrated in FIGS. 15J to 15L, the red, green, and blue color filters include the first portion 121 and the second portion 122 and, in the pixel PX3 as well, the thickness of the second portion 122 of the color filter 120 is formed thinner than that of the first portion 121.

In addition, as illustrated in FIG. 13E, in the pixel PX4, with the exception of the pixel region PR2, the color filter 120 includes, in the pixel regions PR1 and PR3, the first portion 121 having the first transmittance and the second portion 122 having the second transmittance higher than the first transmittance. In contrast, the pixel region PR2 includes only the second portion 122 having the second transmittance. When viewing the pixel PX4 planarly, the ratio of the area of the second portion 122 to the combined area of the first portion 121 and the second portion 122 is greater in the pixel regions PR1 and PR3, compared to that of the pixel PX3 illustrated in FIG. 13D. Furthermore, the ratio of the area that the second portion 122 occupies in the pixel region PR2 is 1, and the transmittance of the color filter 120 of the pixel PX4 is higher than that of the pixel PX3. FIG. 15M is a cross-sectional view taken along line XVm-XVm and is a cross-section of the subpixel SPR illustrated in FIG. 13E. FIG. 15N is a cross-sectional view taken along line XVn-XVn and is a cross-section of the subpixel SPG illustrated in FIG. 13E. FIG. 15O is a cross-sectional view taken along line XVo-XVo and is a cross-section of the subpixel SPB illustrated in FIG. 13E. As illustrated in FIGS. 15M to 15O, the red and blue color filters include the first portion 121 and the second portion 122, the green color filter includes only the second portion 122 and, in the pixel PX4 as well, the thickness of the second portion 122 of the color filter 120 is formed thinner than that of the first portion 121.

In the present embodiment, in the pixels PX to PX4, the transmittance can be increased from the pixel PX to the pixel PX4 by sequentially increasing the ratio, to the area when viewing the pixel regions PR1, PR2, and PR3 planarly, of the area of the second portion 122 having the transmittance higher than that of the first portion 121. Furthermore, in the pixel regions PR1, PR2, and PR3, the ratios of the area of the second portion 122 are varied. The thickness of the color filter changes as a result of providing the high transmittance second portion in the red, green, and blue color filters, and the change in the thickness of the color filter causes a change in chromaticity. It is preferable that this change in chromaticity is in a range that is difficult for the user to visually recognize. Green tends to be the least visibly recognizable on the basis of a change in chromaticity due to a change in film thickness, followed by red. Therefore, the ratio of the second portion is changed according to the color filter, that is, the change of the ratio of the second portion of the green color filter is made the largest, followed by the change of the ratio of the second portion of the red color filter, and the change of the ratio of the second portion of the blue color filter is made the smallest. As a result, it is possible to increase the transmittance from the pixel PX to the pixel PX4 while suppressing changes in chromaticity and preventing chromaticity changes from being visually recognized.

### Embodiment 7

In the following, a liquid crystal display device 10 according to Embodiment 7 is described. In Embodiment 6 described above, an example is described in which the high transmittance second portion is provided in two or more colors among red, green, and blue, and the area ratio of the second portion in each of the red, green, and blue pixels is varied. However, in the present embodiment, the high transmittance second portion is provided in two or more colors among red, green, and blue, and thickness differences, between a reference thickness portion that is the first portion and a thin portion that is the second portion, in each of the red, green, and blue pixels are varied. The features common with the embodiments described above are denoted with the same reference numerals, and detailed descriptions thereof are forgone.

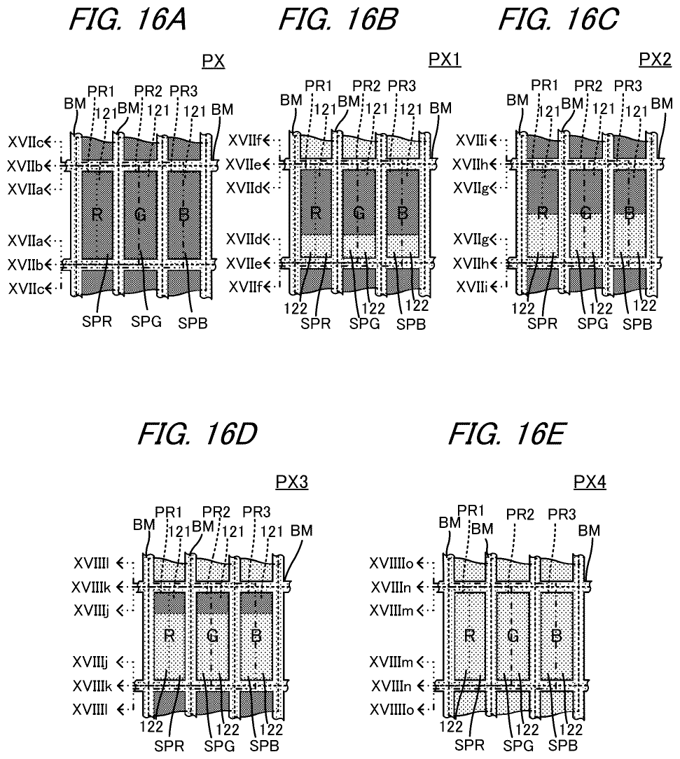

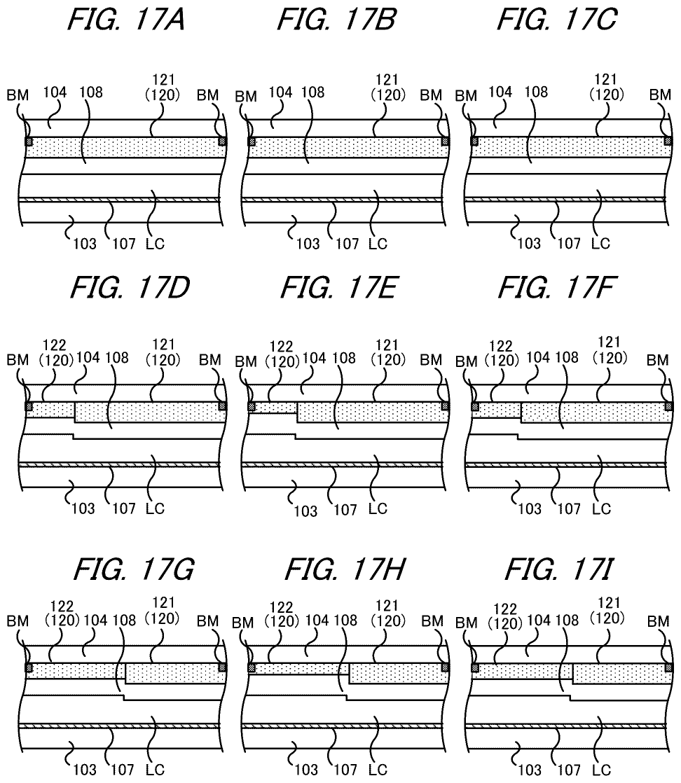

Pixels PX to PX4 according to the present embodiment are illustrated in FIGS. 16A to 16E. As illustrated in FIG. 16A, in the pixel PX, the color filter 120 in the pixel region PR1 of the red subpixel SPR, the pixel region PR2 of the green subpixel SPG, and the pixel region PR3 of the blue subpixel SPB includes only the first portion 121 that has a reference thickness and the first transmittance. In other words, when viewing the pixel PX planarly from the user side, the ratio of the area that the second portion 122 occupies in the pixel regions PR1 to PR3 is zero. FIG. 17A is a cross-sectional view taken along line XVIIa-XVIIa and is a cross-section of the subpixel SPR illustrated in FIG. 16A. FIG. 17B is a cross-sectional view taken along line XVIIb-XVIIb and is a cross-section of the subpixel SPG illustrated in FIG. 16A. FIG. 17C is a cross-sectional view taken along line XVIIc-XVIIc and is a cross-section of the subpixel SPB illustrated in FIG. 16A. As illustrated in FIGS. 17A to 17C, the red, green, and blue color filters include only the first portion 121.

In the pixel PX1, the color filter 120 includes the first portion 121 having the first transmittance and the second portion 122 having the second transmittance higher than the first transmittance. As illustrated in FIG. 16B, the pixel regions PR1, PR2, and PR3 include the first portion 121 and the second portion 122. When viewing the pixel PX1 planarly, the ratios of the area of the second portion 122 to the combined area of the first portion 121 and the second portion 122 are the same in the pixel regions PR1, PR2, and PR3, and are higher compared to that of the pixel PX. As such, the color filter 120 of the pixel PX1 has a higher transmittance than the color filter 120 of the pixel PX. FIG. 17D is a cross-sectional view taken along line XVIId-XVIId and is a cross-section of the subpixel SPR illustrated in FIG. 16B. FIG. 17E is a cross-sectional view taken along line XVIIe-XVIIe and is a cross-section of the subpixel SPG illustrated in FIG. 16B. FIG. 17F is a cross-sectional view taken along line XVIIf-XVIIf and is a cross-section of the subpixel SPB illustrated in FIG. 16B. As illustrated in FIGS. 17D to 17F, the red, green, and blue color filters 120 include the first portion 121 and the second portion 122. In the pixel PX1, the thickness of the second portion 122 of the color filter 120 is formed thinner than that of the first portion 121. Here, the thickness of the second portion 122 of the green color filter 120 in the pixel region PR2 is formed thinner than the thickness of the second portion 122 of the red color filter 120 in the pixel region PR1 and the thickness of the second portion 122 of the blue color filter 120 in the pixel region PR3. Accordingly, for the thickness difference between the first portion 121 that is the reference thickness portion and the second portion 122 that is the thin portion, the thickness difference in the green color filter 120 is greater than the thickness difference in the red and blue color filters 120. By forming the thickness thinly, the transmittance increases even though the area is the same. As a result, in the pixel PX1, the ratios of the area of the second portion 122 of the pixel regions PR1, PR2, and PR3 are the same, but the transmittance of the pixel region PR2 is higher than that of the pixel regions PR1 and PR3. As described above, green tends to be less likely to be visibly recognized on the basis of a change in chromaticity due to a change in film thickness and, as such, even though the thickness difference is great compared to the other colors, a change in chromaticity is less likely to be visually recognized by the user.

Furthermore, in the pixel PX2, the color filter 120 includes the first portion 121 having the first transmittance and the second portion 122 having the second transmittance higher than the first transmittance. As illustrated in FIG. 16C, the pixel regions PR1, PR2, and PR3 of the pixel PX2 include more of the second portion 122 than the pixel PX1. Accordingly, when viewing the pixel PX2 planarly, the ratio of the area of the second portion 122 to the combined area of the first portion 121 and the second portion 122 is greater than in the pixel PX1. As such, the color filter 120 of the pixel PX2 has a higher transmittance than the color filter 120 of the pixel PX1. Here, the ratios of the area that the second portion 122 occupies in each of the pixel regions PR1, PR2, and PR3 are the same. FIG. 17G is a cross-sectional view taken along line XVIIg-XVIIg and is a cross-section of the subpixel SPR illustrated in FIG. 16C. FIG. 17H is a cross-sectional view taken along line XVIIh-XVIIh and is a cross-section of the subpixel SPG illustrated in FIG. 16C. FIG. 17I is a cross-sectional view taken along line XVIIi-XVIIi and is a cross-section of the subpixel SPB illustrated in FIG. 16C. As illustrated in FIGS. 17G to 17I, the red, green, and blue color filter 120 include the first portion 121 and the second portion 122 and, in the pixel PX2 as well, the thickness of the second portion 122 of the color filter 120 is formed thinner than that of the first portion 121. Additionally, the thickness of the second portion 122 of the green color filter 120 is formed thinner than the thickness of the second portion 122 of the color filters 120 of the other colors, and has a higher transmittance.

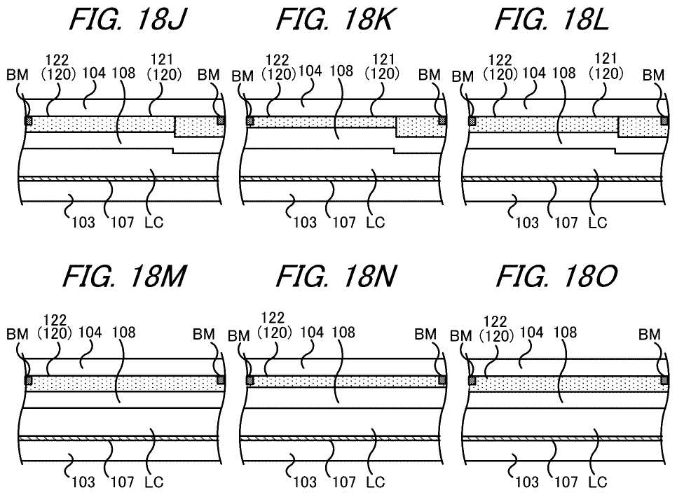

As illustrated in FIG. 16D, in the pixel PX3 as well, the color filter 120 includes the first portion 121 having the first transmittance and the second portion 122 having the second transmittance higher than the first transmittance. When viewing the pixel PX3 planarly, the ratio of the area of the second portion 122 to the combined area of the first portion 121 and the second portion 122 is greater compared to that of the pixel PX2 illustrated in FIG. 16C. As such, the color filter 120 of the pixel PX3 has a higher transmittance than the color filter 120 of the pixel PX2. Here, the ratios of the area that the second portion 122 occupies in the pixel regions PR1, PR2, and PR3 are the same. FIG. 18J is a cross-sectional view taken along line XVIIIj-XVIIIj and is a cross-section of the subpixel SPR illustrated in FIG. 16D. FIG. 18K is a cross-sectional view taken along line XVIIIk-XVIIIk and is a cross-section of the subpixel SPG illustrated in FIG. 16D. FIG. 18L is a cross-sectional view taken along line XVIIIl-XVIIIl and is a cross-section of the subpixel SPB illustrated in FIG. 16D. As illustrated in FIGS. 18J to 18L, the red, green, and blue color filters include the first portion 121 and the second portion 122 and, in the pixel PX3 as well, the thickness of the second portion 122 of the color filter 120 is formed thinner than that of the first portion 121. Additionally, the thickness of the second portion 122 of the green color filter 120 is formed thinner than the thickness of the second portion 122 of the color filters 120 of the other colors, and has a higher transmittance.

As illustrated in FIG. 16E, in the pixel PX4, the color filter 120 includes, in the pixel regions PR1, PR2, and PR3, only the second portion 122 having the second transmittance higher than the first transmittance. When viewing the pixel PX4 planarly, the ratio of the area of the second portion 122 to the combined area of the first portion 121 and the second portion 122 is 1 and, as such, is greater compared to that of the pixel PX3 illustrated in FIG. 16D. FIG. 18M is a cross-sectional view taken along line XVIIIm-XVIIIm and is a cross-section of the subpixel SPR illustrated in FIG. 16E. FIG. 18N is a cross-sectional view taken along line XVIIIn-XVIIIn and is a cross-section of the subpixel SPG illustrated in FIG. 16E. FIG. 18O is a cross-sectional view taken along line XVIIIo-XVIIIo and is a cross-section of the subpixel SPB illustrated in FIG. 16E. As illustrated in FIGS. 18M to 180, in the pixel PX4 as well, the thickness of the second portion 122 of the green color filter 120 is formed thinner than the second portion 122 of the color filters 120 of the other colors, and has a higher transmittance.

In the present embodiment, in the pixels PX to PX4, the transmittance can be increased from the pixel PX to the pixel PX4 by sequentially increasing the ratio, to the area when viewing the pixel regions PR1, PR2, and PR3 planarly, of the area of the second portion 122 having the transmittance higher than that of the first portion 121. Furthermore, in the pixel regions PR1, PR2, and PR3, the thickness differences between the first portion 121 and the second portion 122 are varied. The thickness of the color filter changes as a result of providing the high transmittance second portion in the color filter of the red, green, and blue subpixels, and the change in the thickness of the color filter causes a change in chromaticity. It is preferable that this change in chromaticity is in a range that is difficult for the user to visually recognize. Green tends to be the least visibly recognizable on the basis of a change in chromaticity due to a change in film thickness, followed by red. Therefore, the change in chromaticity can be made less likely to be visually recognized and the required transmittance can be obtained by varying the thickness difference between the first portion 121 and the second portion 122 for every color of the color filters. That is, the thickness difference between the first portion 121 and the second portion 122 of the green color filter is made the largest, followed by the thickness difference of the red color filter, and the thickness difference of the blue color filter is made the smallest. As a result, it is possible to increase the transmittance from the pixel PX to the pixel PX4 while suppressing changes in chromaticity and preventing chromaticity changes from being visually recognized. Note that, in the embodiments described above, the area ratios of the second portion 122 of the filter of each color are the same within the same pixel, but a configuration is possible in which different area ratios are used, and the degree of freedom for setting the transmittance is increased by combining the area ratio with the thickness difference.

Embodiments according to the present disclosure are described above, but the present disclosure is not limited to these embodiments. It would be obvious to a person skilled in the art various changes, modifications, combinations, and the like are possible.

In the embodiments described above, an example is described in which four regions that surround the central region 110 are provided, but the number of regions surrounding the central region 110 is not limited to four. It is sufficient that at least one such region is provided, and the number of regions may be selected as desired. The number and arrangement of the regions that are provided can be changed in accordance with the luminance distribution of the back light 200.

In the embodiments described above, an example is described in which the back light is a local dimming back light, but the present disclosure is not limited thereto. The configuration of the present disclosure can be applied to any liquid crystal display device in which there is a region in which the in-plane luminance of the back light decreases and, as a result, the display region includes regions in which the luminance distribution is not uniform.

In the embodiments described above, an example is described of a case in which the liquid crystal display panel includes three color filters, namely, red, green, and blue color filters. However, the colors of the color filter are not limited thereto. For example, colors other than red, green, and blue may be used, or a single color may be used.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A liquid crystal display device comprising:
an illuminator including a first illumination region having a first luminance, and a second illumination region having a second luminance lower than the first luminance; and
a liquid crystal display including a first region illuminated by the first illumination region, and a second region illuminated by the second illumination region, wherein
a pixel provided in the second region of the liquid crystal display includes a color filter including a first portion having a first transmittance, and a second portion having a second transmittance higher than the first transmittance, and
i) a pixel provided in the first region includes a color filter including only the first portion having the first transmittance, or
ii) a pixel provided in the first region includes a color filter including the first portion having the first transmittance, and the second portion having the second transmittance, wherein a ratio that the second portion occupies with respect to the first portion and the second portion in the pixel provided in the second region of the liquid crystal display is greater than a ratio that the second portion occupies with respect to the first portion and the second portion in the pixel provided in the first region.

2. The liquid crystal display device according to claim 1, wherein a thickness of the second portion is thinner than that of the first portion.

3. The liquid crystal display device according to claim 1, wherein the second portion and the first portion of the color filter are formed from different materials.

4. The liquid crystal display device according to claim 1, wherein the first portion and the second portion are arranged juxtaposed in a stripe-like manner when viewing the pixel planarly.

5. The liquid crystal display device according to claim 1, wherein
the pixel is divided into a plurality of domains, and
in each of the plurality of domains, the ratio that the second portion occupies with respect to the first portion and the second portion is identical.

6. The liquid crystal display device according to claim 2, wherein a cell gap of a region in which the second portion is provided is greater than a cell gap of a region in which the first portion is provided.

7. The liquid crystal display device according to claim 1, wherein
the illuminator is a local dimming back light,
the second illumination region is provided such as to surround the first illumination region, and
the second region is provided such as to surround the first region.

8. The liquid crystal display device according to claim 1, wherein
the color filter includes three colors, namely red, green, and blue, of color filters, and
the second portion is provided in at least one color of the red, green, and blue color filters.

9. The liquid crystal display device according to claim 1, wherein
the color filter includes three colors, namely red, green, and blue, of color filters, and
the second portion is provided in at least two colors of the red, green, and blue color filters, and the ratio that the second portion occupies with respect to the first portion and the second portion varies for every color.

10. The liquid crystal display device according to claim 1, wherein
the color filter includes three colors, namely red, green, and blue, of color filters, and
the second portion is provided in at least two colors of the red. green, and blue color filters, and a thickness difference of the second portion relative to the first portion varies for every color.
